(19) United States
(12) Patent Application Publication
(10) Pub. No.: US 2016/0171737 A1
(43) Pub. Date: Jun. 16, 2016

(54) Method and a Device Thereof for Creating an Album and Previewing the Web Images in the Album

(71) Applicant: Xinyu Xingbang Information Industry Co., Ltd, Xinyu (CN)

(72) Inventors: Xiaohong Yao, Foshan (CN); Zhihong Zhou, Shaoyang (CN)

(73) Assignee: Xinyu Xingbang Information Industry Co., Ltd

(21) Appl. No.: 14/729,046

(22) Filed: Jun. 2, 2015

(30) Foreign Application Priority Data
Dec. 16, 2014 (CN) 201410785194.0

(51) Int. Cl. G06T 11/60; G06F 3/0484; G06F 3/0481

(52) U.S. Cl. CPC G06T 11/60; G06F 3/04812; G06F 3/04845; G06T 2200/24

(57) ABSTRACT

The invention discloses a method and a device thereof for creating an album and previewing the web images in the album. The album comprises a current image previewing area, a previous image area, a next image area, a first image area, a last image area, a first thumbnail wizard area and a second thumbnail wizard area. The previous image area is located on the left side of the current image previewing area and the next image area is located on the right side of the current image previewing area; the first image area is located on one corner position of the current image previewing area and the last image area is located on another corner position of the current image previewing area. The invention has the following beneficial effects: the invention make it rapid and convenient to search images of the album, thus improving the user's experiencing.

### CROSS-REFERENCE TO RELATED APPLICATIONS

The present application claims the benefit of Chinese Patent Application No. 201410785194.0 filed on Dec. 16, 2014, the entire content of which is hereby incorporated by reference.

### FIELD OF THE INVENTION

The invention relates to the field of image previewing, and in particular relates to a method and a device thereof for creating an album and previewing the web images in the album.

### BACKGROUND OF THE INVENTION

At present, the image previewing is realized by placing the corresponding buttons at two sides of an image to be previewed and clicking the button areas at the two sides to switch between the previous image and the next image; if there are lots of images, the user has to click the images repeatedly and will feel tired soon, resulting in the “mouse hand”. And under the circumstances of a plurality of images, it requires several times of clicking to turn to the first or the last image, so, it is quite inconvenient and slow to search the image that brings poor experience to the user.

### SUMMARY OF THE INVENTION

In order to solve the technical problems of the prior art that the image searching is relatively slow and inconvenient and poor experience of the user the invention provides a method and a device for rapidly and conveniently searching and previewing the web images in the album, thus, improving experience of the user.

The technical scheme of the invention to solve the technical problems is as follows: a current image previewing area, a previous image area, a next image area, a first image area, a last image area, a first thumbnail wizard area and a second thumbnail wizard area, the previous image area is located on the left side of the current image previewing area and used for loading the previous image of the current image, and the next image area is located on the right side of the current image previewing area and used for loading the next image of the current image; the first image area is located on one corner position of the current image previewing area and the last image area is located on another corner position of the current image previewing area; the first thumbnail wizard area is arranged at the lower end or upper end of the current image previewing area and used for placing a preset number of thumbnails of the forward images of the current image; the second thumbnail wizard area is arranged at the lower end or upper end of the current image previewing area and used for placing the preset number of thumbnails of backward images of the current image.

According to the album of the invention, the first image area is located on the upper left corner of the current image previewing area; the last image area is located on the lower right corner of the current image previewing area.

According to the album of the invention, the first thumbnail wizard area comprises a first thumbnail forward wizard area and a first thumbnail backward wizard area; the first thumbnail forward wizard area is located on the lower left corner of the current image previewing area and used for taking turns to play thumbnails of the album forward; the first thumbnail backward wizard area is located at the lower end of the current image previewing area and used for taking turns to play thumbnails of the album backward.

According to the album of the invention, the second thumbnail wizard area comprises a second thumbnail forward wizard area and a second thumbnail backward wizard area; the second thumbnail forward wizard area is located at the upper end of the current image previewing area and used for taking turns to play thumbnails of the album forward; the second thumbnail backward wizard area is located on the upper right corner of the current image previewing area and used for taking turns to play thumbnails of the album backward.

According to the album of the invention, the preset number is 5.

According to the album of the invention, the preset time is 5 seconds.

According to the album of the invention, when the mouse moves to and stay in the previous image area or next image area, it switches to the previous or next image of the current image at intervals of a preset time.

The invention further relates to a method for creating an album and previewing the web images in the album, wherein, the method comprises the following steps:

A) Loading a plurality of images to be previewed;

B) Judging whether the images include thumbnail having wizards, if so, creating a first thumbnail wizard area and a second thumbnail wizard area via the thumbnails corresponding to the images, and executing step C); otherwise, directly creating the first thumbnail wizard area and the second thumbnail wizard area via the images, and executing step C);

C) Creating an album;

D) Monitoring the area where the mouse is placed, and switching the images of the album when the mouse is placed in the corresponding area of the album.

According to the method for creating an album and previewing the web images in the album of the invention, in step C), the album establishment includes establishment of a current image previewing area, a previous image area, a next image area, a first image area, a last image area, a first thumbnail wizard area and a second thumbnail wizard area.

The invention further relates to a device for implementing the method for creating an album and previewing the web images in the album, wherein, the device comprises:

A loading unit: for loading a plurality of images to be previewed;

A thumbnail judging unit: for judging whether the images include thumbnail having wizards, if so, creating a first thumbnail wizard area and a second thumbnail wizard area via the thumbnails corresponding to the images; otherwise, directly creating the first thumbnail wizard area and the second thumbnail wizard area via the images;

An album creating unit: for creating an album;

A monitoring unit: for monitoring the area where the mouse is placed, and switching the images of the album when the mouse is placed in the corresponding area of the album.

The method and the device thereof for creating an album and previewing the web images in the album of the invention have the following beneficial effects: since the album comprises a current image previewing area, a previous image area, a next image area, a first image area, a last image area, a first thumbnail wizard area and a second thumbnail wizard area, when the mouse moves to the first image area, indicating that the first image is loaded to the current image previewing area; when the mouse moves to the last image area, indicating that the last image is loaded to the current image previewing area; when the mouse moves to the previous image area, indicating that the previous image of the current image is loaded; when the mouse moves to the next image area, indicating that the next image of the current image is loaded; when the mouse moves to the first thumbnail wizard area, the preset number of thumbnails of forward images of the current image are loaded; and when the mouse moves to the second thumbnail wizard area, the preset number of thumbnails of backward images of the current image are loaded; therefore, the image previewing can be realized by the user without clicking for several times, thus the images in the album can be rapidly and conveniently searched and the experience of the user can be improved.

### BRIEF DESCRIPTION OF THE DRAWINGS

In order to clearly illustrate the technical schemes of the embodiments of the invention or the current art, the drawings of the embodiments or the current art will be briefly described in the following; it is obvious that the described drawings are only related to some embodiments of the invention; for those skilled in the art, on the precondition of not making creative efforts, other attached drawings can be obtained based on the attached drawings below.

FIG. 1 is a structural schematic diagram of the album according to an embodiment of the method and the device thereof for creating an album and previewing the web images in the album;

FIG. 2 is a flow chart of the method for previewing the web images according to the embodiment;

FIG. 3 is a structural schematic diagram of the device according to the embodiment.

### DESCRIPTION OF THE EMBODIMENTS

The technical schemes of the embodiments of the invention will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiments, without any inventive efforts, which should be within the protection scope of the invention.

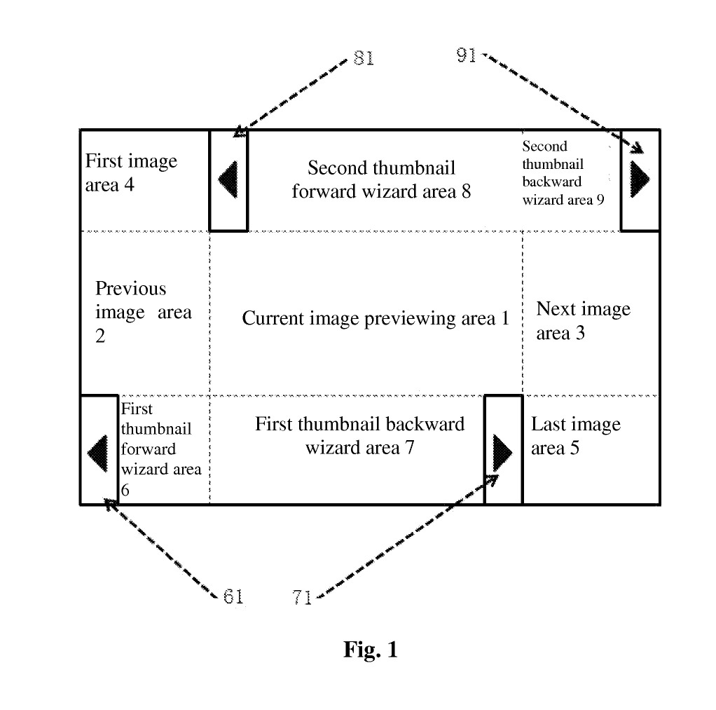

According to the embodiment of the method and the device thereof for creating an album and previewing the web images in the album, the structural schematic diagram of the album is as shown in FIG. 1. And in FIG. 1, the album comprises a current image previewing area 1, a previous image area 2, a next image area 3, a first image area 4, a last image area 5, a first thumbnail wizard area and a second thumbnail wizard area, wherein the first image area 4 is located on one corner position of the current image previewing area 1 and the last image area 5 is located on another corner position of the current image previewing area 1; according to the embodiment, the first image area 4 is located on the upper left corner position of the current image previewing area 1 and the last image area 5 is located on the lower right corner position of the current image previewing area 1. When the mouse moves to the first image area 4, the first image of the album is loaded in the current image previewing area 1 in a manner of cartoon; and when the mouse moves to the last image area 5, the last image of the album is loaded in the current image previewing area 1 in a manner of cartoon.

According to the embodiment, the previous image area 2 is located on the left side of the current image previewing area 1 and the next image area 3 is located on the right side of the current image previewing area 1; the previous image area 2 and the next image area 3 respectively correspond to the previous image and the next image of the current image previewing area 1; when the mouse moves to the previous image area 2, the previous image of the current image is loaded, and when the mouse moves to the next image area 3, the next image of the current image is loaded. It is worth mentioning that it switches from the previous or next image of the current image to the first or last image at intervals of a preset time when the mouse moves into and stay in the previous image area 2 or the next image area 3, thus the user is not necessary to continuously click the mouse; therefore, the number of times that the user clicks the mouse is reduced and the user can search the required image by fewer operations, hand fatigue of the user can be relieved, experience of the user will be improved accordingly. According to the embodiment, the preset time is 5 seconds. Certainly, under some circumstances, the preset time can be correspondingly regulated in accordance with the specific circumstance.

According to the embodiment, the first thumbnail wizard area is arranged at the lower end or upper end of the current image previewing area 1 and used for placing a preset number of thumbnails of the forward images of the current image; the second thumbnail wizard area is arranged at the upper end or lower end of the current image previewing area 1 and used for placing the preset number of thumbnails of backward of images of the current image. According to the embodiment, the preset number is 5 images. That is to say, the first thumbnail wizard area is used for placing the 5 thumbnails of the forward images of the current image and the second thumbnail wizard area is used for placing the 5 thumbnails of the backward images of the current image. According to the embodiment, the first thumbnail wizard area comprises a first thumbnail forward wizard area 6 and a first thumbnail backward wizard area 7; the first thumbnail forward wizard area 6 is located on the lower left corner of the current image previewing area 1 and used for taking turns to play thumbnails of the album forward; the first thumbnail backward wizard area 7 is located at the lower end of the current image previewing area 1 and used for taking turns to play thumbnails of the album backward. A first forward icon 61 is arranged at the left end of the first thumbnail forward wizard area 6, indicating that the first thumbnail forward wizard area 6 is a forward area. A first backward icon 71 is arranged at the right end of the first thumbnail backward wizard area 7, indicating that the first thumbnail backward wizard area 7 is a backward area.

According to the embodiment, the second thumbnail wizard area comprises a second thumbnail forward wizard area 8 and a second thumbnail backward wizard area 9; the second thumbnail forward wizard area 8 is located at the upper end of the current image previewing area 1 and used for taking turns to play thumbnails of the album forward; the second thumbnail backward wizard area 9 is located on the upper right corner of the current image previewing area 1 and used for taking turns to play thumbnails of the album backward. A second forward icon 81 is arranged at the left end of the second thumbnail forward wizard area 8, indicating that the second thumbnail forward wizard area 8 is a forward area. A second backward icon 91 is arranged at the right end of the second thumbnail backward wizard area 9, indicating that the second thumbnail backward wizard area 9 is a backward area. When the user wants to search the image of the album rapidly, the mouse is moved to the first thumbnail forward wizard area 6, the first thumbnail backward wizard area 7, the second thumbnail forward wizard area 8 or the second thumbnail backward wizard area 9, and when the mouse is moved to the four areas, the first thumbnail forward wizard area 6, the first thumbnail backward wizard area 7, the second thumbnail forward wizard area 8 or the second thumbnail backward wizard area 9 will automatically take turns to play the images of the album forward or backwards, and the required images can be conveniently and rapidly searched. Certainly, under some circumstances of the embodiment, the positions of the current image previewing area 1, the previous image area 2, the next image area 3, the first image area 4, the last image area 5, the first thumbnail wizard area and the second thumbnail wizard area can be regulated accordingly.

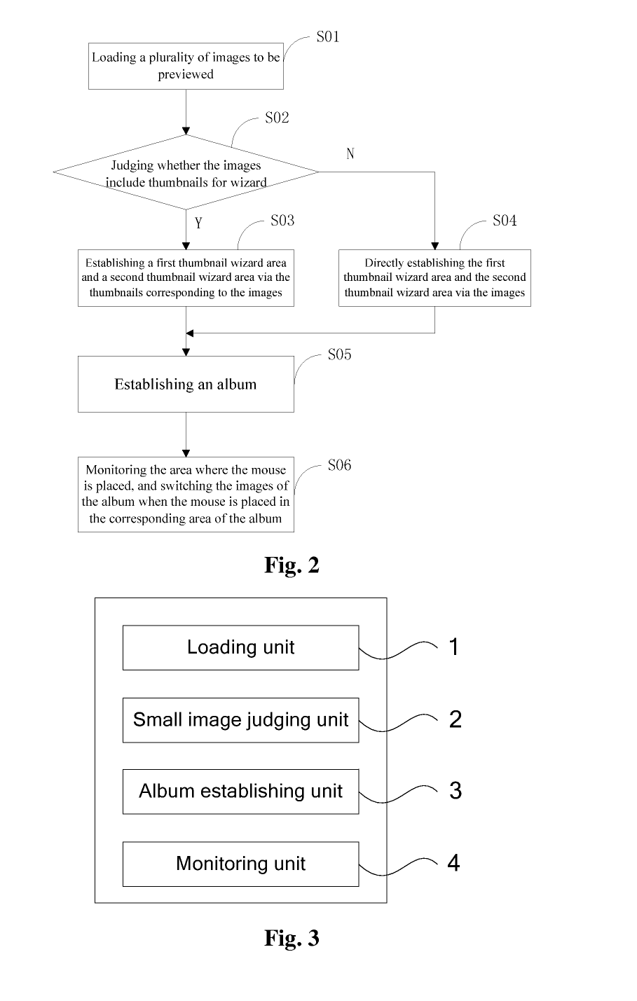

According to the embodiment, the invention further relates to a method for previewing the web images, and the flow chart is as shown in FIG. 2. And in FIG. 2, the method for previewing the web images comprises the following steps:

Step S01: loading a plurality of images to be previewed: in this step, the images to be previewed are loaded.

Step S02: judging whether the images include thumbnails having wizards: in this step, it judges whether the images include thumbnails having wizards, if so, executing step S03, otherwise, executing step S04.

Step S03: creating a first thumbnail wizard area and a second thumbnail wizard area via the thumbnails corresponding to the images: if the judgment result of the step S02 is positive, executing this step. In this step, it establishes a first thumbnail wizard area and a second thumbnail wizard area via the thumbnails corresponding to the images. After this step, executing step S05.

Step S04: directly creating the first thumbnail wizard area and the second thumbnail wizard area via the images: if the judgment result of the step S02 is negative, executing this step. In this step, it directly establishes the first thumbnail wizard area and the second thumbnail wizard area via the images. After this step, executing step S05.

Step S05: creating an album: in this step, an album is established. When creating the album, it includes establishment of a current image previewing area, a previous image area, a next image area, a first image area, a last image area, a first thumbnail wizard area and a second thumbnail wizard area.

Step S06: monitoring the area where the mouse is placed, and switching the images of the album when the mouse is placed in the corresponding area of the album: in this step, it monitors the area where the mouse is placed, and switches the images of the album when the mouse is placed in the corresponding area of the album. Conventional image previewing is realized by clicking the images for several times, which will become troublesome when many images are to be previewed, and workload of the user is increased. The invention, under a circumstance that many images are to be previewed by the user, can reduce the time that user clicks the mouse, relieve hand fatigue and improve the user experiencing, and simultaneously can make it rapid and convenient to search the images in the album.

The invention further relates to a device for implementing a method for creating an album and previewing the web images in the album, and the structural schematic diagram is as shown in FIG. 3. And in FIG. 3, the device comprises a loading unit 1, a thumbnail judging unit 2, an album creating unit 3 and a monitoring unit 4, wherein, the loading unit 1 is used for loading a plurality of images to be previewed; the thumbnail judging unit 2 is used for judging whether the images include thumbnail having wizards, if so, creating a first thumbnail wizard area and a second thumbnail wizard area via the thumbnails corresponding to the images, otherwise, directly creating the first thumbnail wizard area and the second thumbnail wizard area via the images; the album creating unit 3 is used for creating the album; the monitoring unit 4 is used for monitoring the area where the mouse is placed, and switching the images of the album when the mouse is placed in the corresponding area of the album.

In conclusion, according to the embodiment, a plurality of images can be previewed by monitoring the area of the mouse in the album. The invention can make it rapid and convenient to search the images in the album, and can simultaneously reduce the number of times that the user clicks the mouse, so, the user can search the required images through fewer operations, thus relieving hand fatigue and enhancing experience of the user.

The foregoing embodiments are merely exemplary embodiments of the invention, and not intended to define the scope of the invention, and any modification, equivalent replacement, improvement and the like within the spirits and the principles of the invention shall be included within the protection scope of the invention.

What is claimed is:

1. An album, wherein comprises a current image previewing area, a previous image area, a next image area, a first image area, a last image area, a first thumbnail wizard area and a second thumbnail wizard area, the previous image area is located on the left side of the current image previewing area and used for loading the previous image of the current image, and the next image area is located on the right side of the current image previewing area and used for loading the next image of the current image; the first image area is located on one corner position of the current image previewing area and the last image area is located on another corner position of the current image previewing area; the first thumbnail wizard area is arranged at the lower end or upper end of the current image previewing area and used for placing a preset number of thumbnails of the forward images of the current image; the second thumbnail wizard area is arranged at the lower end or upper end of the current image previewing area and used for placing the preset number of thumbnails of the backward images of the current image.

2. The album according to claim 1, wherein, the first image area is located on the upper left corner of the current image previewing area; the last image area is located on the lower right corner of the current image previewing area.

3. The album according to claim 2, wherein, the first thumbnail wizard area comprises a first thumbnail forward wizard area and a first thumbnail backward wizard area; the first thumbnail forward wizard area is located on the lower left corner of the current image previewing area and used for taking turns to play thumbnails of the album forward; the first thumbnail backward wizard area is located at the lower end of the current image previewing area and used for taking turns to play thumbnails of the album backward.

4. The album according to claim 3, wherein, the second thumbnail wizard area comprises a second thumbnail forward wizard area and a second thumbnail backward wizard area; the second thumbnail forward wizard area is located at the upper end of the current image previewing area and used for taking turns to play thumbnails of the album forward;
the second thumbnail backward wizard area is located on the upper right corner of the current image previewing area and used for taking turns to play thumbnails of the album backward.

5. The album according to claim 1, wherein, the preset number is 5.

6. The album according to claim 5, wherein, when the mouse moves to and stay in the previous image area or next image area, it switches to the previous or next image of the current image at intervals of a preset time.

7. The album according to claim 6, wherein, the preset time is 5 seconds.

8. The album according to claim 2, wherein, the preset number is 5.

9. The album according to claim 8, wherein, when the mouse moves to and stay in the previous image area or next image area, it switches to the previous or next image of the current image at intervals of a preset time.

10. The album according to claim 9, wherein, the preset time is 5 seconds.

11. The album according to claim 3, wherein, the preset number is 5.

12. The album according to claim 4, wherein, the preset number is 5.

13. A method for creating an album and previewing the web images in the album, wherein it comprises the following steps:
A) Loading a plurality of images to be previewed;
B) Judging whether the images include thumbnails having wizards, if so, creating a first thumbnail wizard area and a second thumbnail wizard area via the thumbnails corresponding to the images, and executing step C); otherwise, directly creating the first thumbnail wizard area and the second thumbnail wizard area via the images, and executing step C);
C) Creating an album;
D) Monitoring the area where the mouse is placed, and switching the images of the album when the mouse is placed in the corresponding area of the album.

14. The method for creating an album and previewing the web images in the album according to claim 13, wherein, in step C), the album creating includes creation of a current image previewing area, a previous image area, a next image area, a first image area, a last image area, a first thumbnail wizard area and a second thumbnail wizard area.

15. A device for implementing the method for creating an album and previewing the web images in the album according to claim 13, wherein, the device comprises:
A loading unit: for loading a plurality of images to be previewed;
A thumbnail judging unit: for judging whether the images include thumbnails having wizards, if so, creating a first thumbnail wizard area and a second thumbnail wizard area via the thumbnails corresponding to the images; otherwise, directly creating the first thumbnail wizard area and the second thumbnail wizard area via the images;
An album creating unit: for creating the album;
A monitoring unit: for monitoring the area where the mouse is placed, and switching the images of the album when the mouse is placed in the corresponding area of the album.
